(19) United States
(12) Patent Application Publication
(10) Pub. No.: US 2002/0039432 A1
(43) Pub. Date: Apr. 4, 2002

(54) Legal age limit and fingerprint verification system

(76) Inventor: Ramiz G. Sheena, West Bloomfield, MI (US)

Correspondence Address: John G. Posa, Gifford, Krass, Groh et al, Suite 400, 280 N. Old Woodward Ave., Birmingham, MI, 48009, US

(21) Appl. No.: 09/968,169

(22) Filed: Oct. 1, 2001

Related U.S. Application Data
(60) Provisional application No. 60/236,962, filed on Sep. 29, 2000.

(51) Int. Cl. G06K 9/00

(52) U.S. Cl. 382/115

(57) ABSTRACT

The present invention discloses a system that issues to verify personal identification information associated with a personal identification card, such as a driver's license. The invention comprises uses a scanner disposed at a user site for scanning a personal identification card that is encoded with personal identification information. Preferably this information is encoded on a magnetic strip disposed on a personal identification card. A central database is provided that contains authentic personal identification information which corresponds to the information encoded on a personal identification card. A computer is disposed at the user's site and is in communication with the scanner and at the central database. A computer is contained therein and is operative to search and retrieve the authentic personal identification information corresponding to the personal identification information encoded on the personal identification card.

### REFERENCE TO RELATED APPLICATION

This application claims priority from U.S. provisional patent application Ser. No. 60/236,962, filed Sep. 29, 2000, the entire contents of which is incorporated herein by reference.

### BACKGROUND OF THE INVENTION

Teenagers are starting to drink earlier then ever, typically at age thirteen or fourteen, and more of them are drinking to intoxication. Additionally, more than a million teenagers in the United States start smoking and drinking each year despite an increase in the number of laws designed to keep them away from tobacco and alcohol.

States and towns have adopted or are considering laws that increase penalties for retailers who sell cigarettes to teens or fail to ask for proof of age. Obviously, minors can not smoke or drink if they can not get it and so a primary goal is to keep the products out of the reach of minors.

There is a strict rule that a store owner must check a person's ID when they purchase liquor or tobacco. In most states, the legal age for tobacco is 18 and for liquor, 21. In efforts to deter the intentional of negligent sales of tobacco and alcohol to minors, law enforcement agencies have been recruiting high school students who look like they are over 21 but are provided with driver's licenses, or other identification, indicating that they are under age. These decoys are sent into the stores of suspected violators who are fooled into serving them because they look older and, as a result, the store managers will receive a citation and/or, depending on local regulations, will also be fined or even jailed.

### SUMMARY OF THE INVENTION

The present invention provides a system for verifying the age and/or identity of a holder of a personal identification information card such as a driver's license, State ID, employment ID, or other identification mediums, that are sometimes falsified or counterfeited.

The system includes a scanner for scanning information encoded in the holder's identification information card, a central database including authentic identification information that corresponds to the holder's identification information, a computer in communication with the scanner and the central database, and a computer program contained within the computer operative to search and retrieve the potential purchaser's identification information from the central database.

In the preferred embodiment, identification information is encoded on a magnetic strip disposed on the individual's driver's license or State ID. Alternatively, the encoded information is in the form of a bar code that can be scanned through an optical character reader. In this embodiment, update information can simply be input into the central database and the updated bar code encoded information can be printed out onto an adhesive strip that can be attached to the individual's identification medium. Most preferably, a fingerprint will be added to the individual's identification medium as an exact indicator of personal identification that is highly immune to mismatch error and falsification.

A central database stores the personal identification information and is either located at the user site or a remote site. The identification information would typically include an individual's date of birth, home address, height, weight, eye color, and ethnicity. The database is in communication with a computer located at the user site that processes information received via the scanner, or other input device, from the individual's identification medium. A computer program contained within the computer operates to search and retrieve identification information from the database that substantially matches the information obtained from the personal identification medium. If no information is retrieved from the database, then the computer program is operative to provide the system user with an appropriate message indicating that no record was found which substantially matches the information obtained from the identification medium.

The present invention reduces the chances of minors purchasing alcohol or tobacco through the use of false identification. Alternatively, the invention may be used to prevent individuals from using false identification for other types of illegal activities, such as unauthorized access controlled materials or unauthorized entry into secure areas.

### BRIEF DESCRIPTION OF THE DRAWINGS

FIG. 1 is a plan view of the identification verification system as according to the invention.

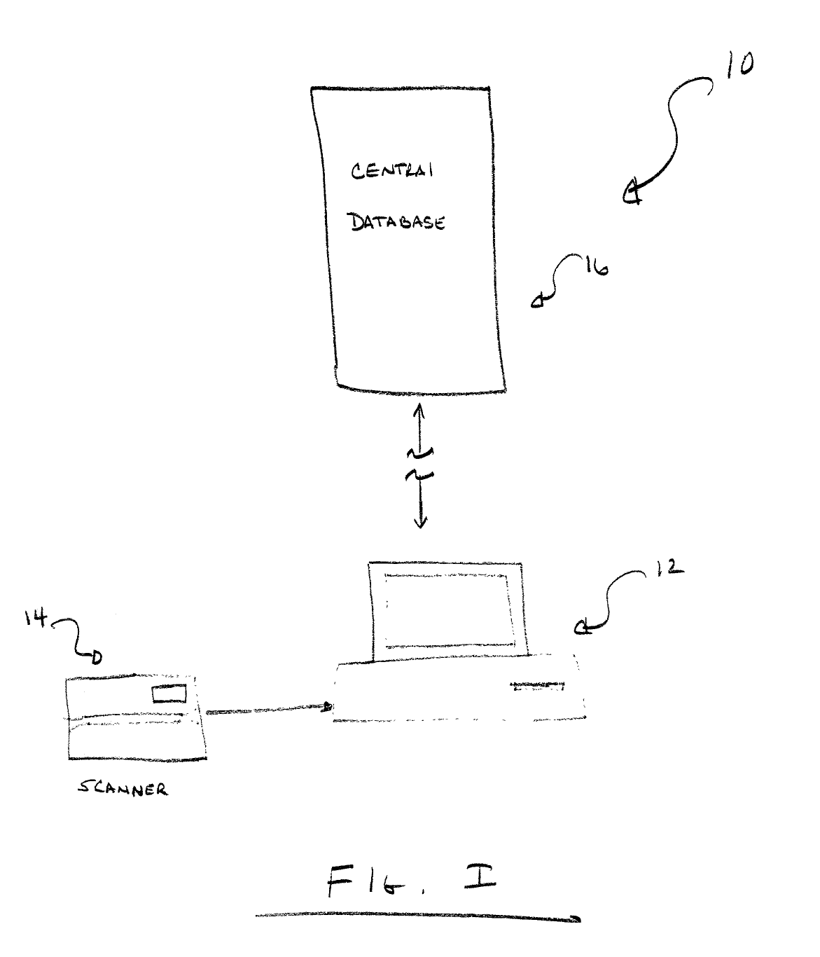

### DETAILED DESCRIPTION OF THE INVENTION

Broadly according to this invention, a scanner is provided at each store, which is used to read information off of a potential purchaser's driver's license and a fingerprint. Most conveniently, such information would be the information encoded in the magnetic strip which has the operator's date of birth. However, if that is not available, a more sophisticated version of the invention might be able to look at the front side of the license, and through optical character recognition, pick out where the date of birth is. Moreover, a fingerprint can be added onto the license that can prove to be beneficial to officials, retailers and banks.

This scanner can be used in a number of places. It can be used on the cooler doors so that unless you have a driver's license that says you are of age, you will be prevented from entering the cooler to pick out what you want. It could be used on the cash register, for example, where it has keys that you press for beer, wine, liquor or cigarettes, such that an under-age person will not be able to press those keys unless the scanner shows a legal age. If the store is a liquor store, the scanner may be provided on the front door, so that one cannot even enter the store without a proper driver's license.

In the preferred embodiment, you would not only have to swipe your driver's license, or have it read, but a potential purchaser will also have to press a button. The button would be an acknowledgement, effectively stating that ‘yes I am of age to buy alcohol.’ Depressing the button would unlock the keys of the cash register and allow the person to take another look at your license, but it would also require, in this case, an active motion to be made by the person to prove that they are in effect saying that they are old enough to buy the age-protected materials.

The system could also preferably keep track of the transaction, in other words, to record that “this person came in on x day, pressed the button saying that they were of age, presented their driver's license and were sold liquor.” Using this more comprehensive version of the apparatus will help, if later the police come by to accuse the store owner of selling to underage individuals, you could print this out to at least minimize liability.

As an alternative embodiment, if somebody comes in and legitimately buys alcohol, but then comes back in later and does not have an ID, the system would record more than one thing about the person. For instance, it would record not only his driver's license but also a fingerprint. Then the next time the same person comes into the store without proper ID, the fingerprint would do because he would get a match. You could do a voice pattern or a high resolution photograph of the individual.

In addition to making it easier for retailers, this invention may also help government officials. For example, the Secretary of State can add a new section on the operator's license for a fingerprint. This will help officials find out the true identity of those with no identification when pulled over or in an accident.

Revenue will be generated through a fee split between inventor and Secretary of State. The use of a fingerprint will enable not only in minimizing under age drinking and smoking, but also officials in cases of no identification on their person. Banks can also benefit in cases of check-cashing, this will minimize fraud and keep track of individuals more easily and with less paperwork.

I claim:

1. A system for preventing the purchase of liquor or cigarettes by underage individuals, comprising:
a scanner disposed at a store selling such items for scanning a potential purchaser's driver's license; and
a reader for determine the age of the potential purchaser from the driver's license.

2. The system of claim 1, wherein:
the driver's license includes a magnetic stripe; and
the reader reads the stripe.

3. The system of claim 1, wherein:
the reader reads a date through optical character recognition.

4. The system of claim 1, further including a button that the potential purchaser needs to press to verify that they are of legal age.

5. The system of claim 1, wherein if a potential purchaser does not have a license and is a regular customer may use fingerprint, or form of voice pattern or a photograph.

6. A system for verifying personal identification information of an individual comprising:
a scanner disposed at a user site, said scanner capable of scanning an individual's personal identification information card to obtain encoded personal identification information;
a central database, said database including personal identification information corresponding to said individual's personal identification information scanned from;
a computer disposed at said user site, said computer in communication with said scanner and said central database; and
a computer program contained within said computer operative to:
interpret said personal identification information scanned by the scanner,
search and retrieve personal identification information from the central database relative to the identification information scanned.

7. The system of claim 6, wherein:
the personal identification information card includes a magnetic stripe, the scanner reads the stripe.

8. The system of claim 6, wherein:
the computer reads a date through optical character recognition.

9. The system of claim 6, wherein if an individual does not have a personal identification information card a fingerprint, form of voice pattern, or a photograph may be used as personal identification information.
